(19) United States
(12) Patent Application Publication
(10) Pub. No.: US 2015/0120609 A1
(43) Pub. Date: Apr. 30, 2015

(54) Methods and systems for providing liquidity on exchange-traded investment vehicles, including exchange-traded funds, while preserving the confidentiality of their holdings

(71) Applicant: TARIK RIVIERE, New York City, NY (US)

(72) Inventor: TARIK RIVIERE, New York City, NY (US)

(21) Appl. No.: 14/062,396

(22) Filed: Oct. 24, 2013

(51) Int. Cl. G06Q 40/06

(52) U.S. Cl. CPC G06Q 40/06
USPC 705/36 R

(57) ABSTRACT

Methods and computer-based system to enable an exchange-traded vehicle to facilitate hedging by a third party against the value of the investment portfolio of the said exchange-traded vehicle. The methods and system disclosed enable a dedicated entity, closely integrated with the exchange-traded vehicle, to offer reliable hedging services while preserving the confidentiality of the said vehicle's investment portfolio holdings. Processes around control and performance reporting for the dedicated entity eliminate potential conflicts of interest and ensure adequate transparency to market participants.

### CROSS REFERENCE TO RELATED APPLICATIONS

This application claims preference to U.S. Provisional Patent Application No. 61/717,686, filed Oct. 24, 2012.

### PRELIMINARY COMMENTS

Active ETFs increasingly are an area of focus in financial markets. After gaining initial traction in recent years, the sector now offers unrivalled potential for growth. Recognizing the inherent limits of the passive ETF model in the actively managed space, and seizing on the commercial opportunity, participants have recently invested time and efforts to propose alternative structures and processes.

In the meantime, tried and tested methods developed by the technology industry in the past decade to help exchange services and information hint at a novel and original approach to risk transfer. This approach yields a robust and scalable method for streamlining the way market participants hedge their exposure to actively managed vehicles, including active ETFs, while protecting the confidentiality of underlying investment portfolios.

This new framework implies a profound change in the way we approach investments in actively traded vehicles, rather than a marginal improvement in the existing passive ETF model. With this invention, the notion of providing liquidity on an actively managed vehicle is inextricably linked to the vehicle itself. The end investor is not only exposed to the primary investment strategy of the vehicle, but in addition to profits and losses stemming from the active role the vehicle plays in facilitating the risk transfer process.

### BACKGROUND

Exchange-traded funds (ETFs) are a type of investment vehicle that can be bought and sold similarly to common stocks on major exchanges. As an investment vehicle, ETFs were first available in the US in 1993. They were initially limited to passive index funds, and their investment objective was traditionally to replicate the performance of an underlying benchmark index. The underlying for such index was generally a basket of equities, bonds, commodities or currencies or a hybrid. These ETFs' investment methodology was generally made public and enabled market participants to determine the vehicle's portfolio composition at all time.

In 2008, the first actively managed ETFs were authorized by the Securities and Exchange Commission. Recently, as of Aug. 16, 2013, assets under management in active ETFs stood at $14.37bn. There were 63 distinct active ETFs, delivering 12 different types of strategies. Still, passive ETFs represented 99% of AUM outstanding, demonstrating the potential for growth for actively managed products. As a comparison, the assets allocated in active mutual funds were recently estimated at $8.5trn, or 73% of the aggregate allocation to mutual funds ($11.6trn).

Recent active ETF launches met strong investor demand. A popular fixed income mutual fund made its strategy available in the active ETF format in Q1 2012 with minor adjustments and restrictions (Ticker ‘BOND’). Assets under management for this ETF stood at $3.8bn as of October 2013.

Risk transfer inadequacies linked to the passive ETF model remain an impediment to growth for the active ETF sector. Market makers' reliance on the availability of the ETF investment portfolio composition at all time for valuation and hedging creates issues of confidentiality and scale. The logistics of making markets on a large number of highly dynamic and complex active ETFs in heterogeneous markets are cumbersome using a passive ETF methodology.

Partial attempts were made to address these issues in the past. One approach involved proxy hedging, which offered a level of confidentiality at the investment portfolio level. However, the inaccuracy of the hedge held by the market maker implied an almost certain deterioration in liquidity provided to end investors. (U.S. Pat. No. 8,170,934 Weber et al.) Additionally, the logistics were fairly complex, raising issues of scalability in this approach. Other works introduced methods providing NAV and IIV pricing throughout the day while protecting confidentiality. (U.S. Pat. No. 7,925,562 Kunhle et al.) Similar comments on complexity and scalability could be made with regards to logistics and implementation.

Many agree that, to be successful, a novel active ETF design should retain as many of the popular passive ETF features as possible: liquidity, transparency, tax effectiveness and low expense ratios stemming from reduced implementation costs. In particular, the in-kind creation and redemption process should be preserved to the extent possible as it provides an effective mechanism to align individual tax liabilities and individual investment decisions.

Exchanging services and information has evidently been a central topic in technology with the commercialization of the internet. Effective and scalable solutions had to be developed. With a considerable and ever growing online consumer presence, these commercial methods to exchange services and information have been deployed and put to the test in an unprecedented scale.

A key challenge there for interoperability was the heterogeneous nature of a network such as the internet. From an abstract standpoint, it implied additional work was required to facilitate communication between entities that had no prior knowledge of each other and often operated very differently. Internalization was a powerful way of solving the problem, whereby the task of facilitating communication was handled by the provider of a given service. This approach gained tremendous traction in technology, and is the basis for widely used self described structures and metadata.

Solving the issue of valuation and risk transfer for active ETFs via internalization can be achieved. In this framework, the investment vehicle is effectively offering services to third parties such as hedging on the valuation of its own portfolio. The investment proposition here is fundamentally different from the one implied by the passive ETF model. In addition to the returns generated by the stated primary investment strategy, the investor is now exposed to the potential profit and loss generated when the active ETF offers services such as hedging on its own portfolio.

To implement this framework successfully, one has to overcome several challenges. First, one should determine the practical method by which an active ETF offers services such as hedging on its own portfolio. Second, the framework should ensure that incentive alignment across participants in the said framework is such that investors can reasonably expect equal or superior service compared with what they typically experience within the current passive ETF framework. Finally, investors should be provided with adequate transparency so that they can delineate revenues and costs associated with the active ETF primary investment strategy vs. those resulting from the hedging services provided.

### DETAILED DESCRIPTION

The invention includes methods for internalizing hedging services for an exchange-traded vehicle, i.e. for the exchange-traded vehicle itself to offer third parties including market-makers a scalable way to hedge the value of the said exchange-traded vehicle investment portfolio. From an investor standpoint, the framework needs to offer adequate transparency and mitigate potential conflicts of interest arising from the aggregation of these two distinct functions inside a single investment vehicle.

The benefit from a risk transfer perspective is to offer participants including market makers a way to streamline the hedging of highly dynamic and sophisticated active exchange traded vehicles, enabling them to focus on order flow and scale by simplifying hedging. Instead of having to assess portfolio composition and hedge every change in the underlying position, participants can now adjust their exposure to the active vehicle by entering into a single derivatives transaction. It is conceivable that a single market maker could reliably offer liquidity on tens of highly complex, highly dynamic underlying strategies in that framework.

In one embodiment, the hedging services are offered by making markets on an exchange-traded derivative contract linked to the value of the said exchange-traded vehicle portfolio. Derivatives are by design the most effective financial instruments to effectuate risk transfer and therefore the adequate tool for participants to utilize for hedging. In addition, accessing these derivatives on an exchange brings transparency and simplicity.

In a preferred embodiment, the actively managed investment vehicle is comprised of two legal entities. The first entity, referred to as the core entity, executes the primary investment strategy, and is invested in a second entity, referred to as the meta hedge provider, which is in charge of actively making markets on a financial instrument linked to the value of the investment portfolio of the said core entity. In this embodiment, the core entity is the entity traded on an exchange and purchased or sold by end investors.

The core entity maintains constant, secure and confidential communication with the meta hedge provider at all times. The core entity communicates in a timely manner every change in the composition of its investment portfolio to the meta hedge provider.

In a preferred embodiment, the communication channel between the core entity and the meta hedge provider consists of a private and secure physical connection between the network adapters of the computer systems of each respective entity. An exemplary connection would be an optical fiber cable.

In one embodiment at least, the core entity is the sole investor in the meta hedge provider.

In one embodiment, the said financial instrument used by the meta hedge provider to actively make markets is an exchange traded single stock future contract, linked to the value of the investment portfolio of the core entity.

In a further embodiment, the core entity and the meta hedge provider are both organized as limited partnerships. Here the core entity is a limited partner of the meta hedge provider, and the sponsor is the general partner of both entities. End investors are limited partners of the core entity.

In at least one embodiment the core entity publicly discloses the return of its investment in the meta hedge provider, at a predetermined adequate frequency. In a further embodiment, the frequency is daily.

In one embodiment, the core entity publicly and periodically discloses the actual capital invested in the meta hedge provider. In another embodiment, the sponsor of the exchange traded vehicle discloses the breakdown of the initial capital commitment to the core entity and the meta hedge provider.

In a further embodiment, minimum requirements are set for the meta hedge provider, including but not restricted to maximum quoted bid-offer spread and minimum size commitment. A predetermined contingency operating mode may be enforced in the event that the meta hedge provider fails to meet the minimum liquidity requirements.

In at least one embodiment, the contingency operating mode consists of the meta hedge provider making the investment vehicle composition available publicly, and communicating every subsequent changes in the said portfolio composition in a timely manner to the public. In this situation, independent market-makers are in a position to step in and provide liquidity on the core entity in lieu of the meta hedge provider.

Specifically, from inception of the investment vehicle, the meta hedge provider maintains a public electronic depository in the form of an electronic document stored on a segregated computer system maintained by the said meta hedge provider, and accessible by the public via the internet. A processor, within the said meta hedge provider computer systems, accessing information stored within the said systems, tracks every change in the core entity investment portfolio and sends instructions to the said segregated system to update the content of the electronic document accordingly.

Overall, the benefit of this invention is to deliver a framework for providing intraday liquidity on an exchange-traded vehicle while maintaining adequate confidentiality on an underlying investment portfolio; this being achieved by integrating a liquidity providing entity within the investment vehicle itself.

In addition to delivering scalability and streamlining the risk transfer process, this invention brings other benefits to market participants. When uncertain market conditions cause numerous purchases and sales of the investment vehicle by end investors, there is an economic cost to the exchange traded vehicle for constantly adjusting its exposure.

This diversion of the vehicle's resources to handle short term investor flow is all the more pronounced when the strategy is highly dynamic, the underlying instruments illiquid and the portfolio complex. In the legacy passive ETF model, none of the resource cost incurred by the said ETF while hedging marginal flows is adequately factored in and mitigated. In many cases however, because of the passivity of the said ETF underlying investment portfolios, this limitation is acceptable.

In the context of this invention, the meta hedge provider is a component that allows for adequately compensating investors for this resource usage. The meta hedge provider should, within specific constraints including minimum liquidity requirements, adjust its market making policy including bid-offer spread contributed in order to adequately compensate existing investors for the diversion of resources caused by marginal flows.

Incentives to promote highly efficient and competitive hedging are well aligned in this framework. By design, the purpose of the meta hedge provider is to facilitate risk transfer around the exchange traded vehicle. Because the said meta hedge provider is tied by construction to the long term success of the exchange-traded vehicle, and because the said meta hedge provider specific performance is disclosed publicly, consistency and predictability are incentivized. Opportunistic and predatory behaviors are de-incentivized as they would immediately be visible and damaging to the marketing appeal of the investment vehicle.

The close integration of the core investment vehicle and the meta hedge provider brings economies of scale at the aggregate marketplace level. In the legacy passive ETF framework, market makers have to derive the composition of an exchange-traded vehicle at all time to determine the hedging required. They subsequently need to execute these hedges in numerous markets in which they may not have any specific expertise nor experience. In particular it would be cumbersome and costly to apply for membership with each and every exchange that a large number of active vehicles could potentially have exposure to. On a large scale, the legacy risk transfer process is sub-optimal for active vehicles, prone to errors and inherently a wasteful use of resources and human capital. The inadequacy is more evident in underlying niche markets, where liquidity is scarce and expert knowledge is required. In many of these cases, embedding the meta hedge provider in the exchange-traded vehicle helps leverage the expertise of the said exchange-traded vehicle management team and delivers practical efficiencies.

### BRIEF DESCRIPTION OF THE DRAWINGS

FIG. 1 shows a method by which the meta hedge provider (103) actively makes markets on a derivative linked to the value of the core entity.

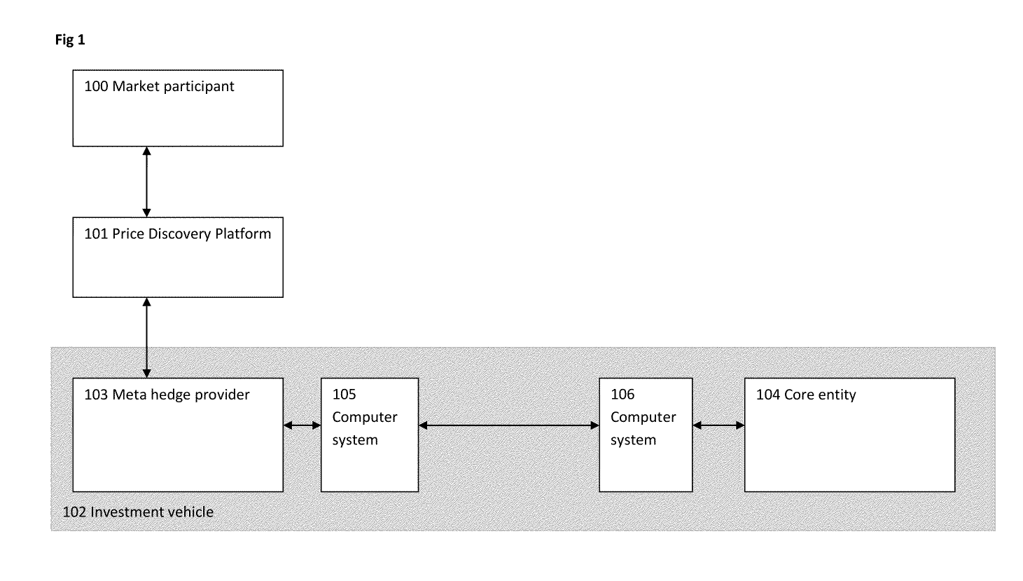

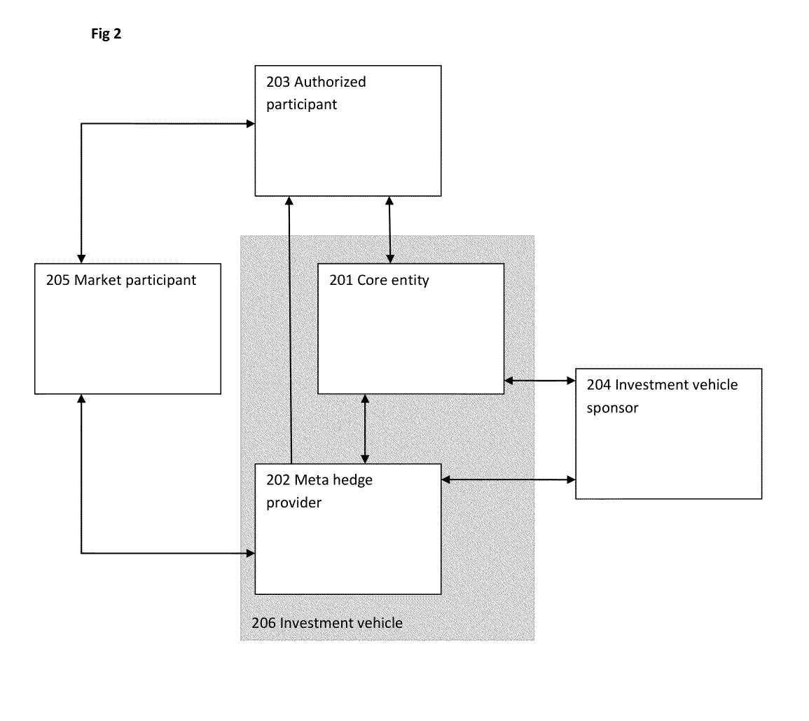

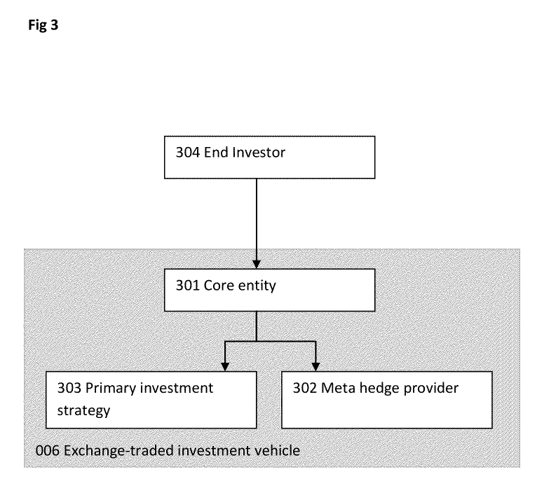

The computer system (105) of the meta hedge provider has a secure connection to the computer system (106) of the core entity (104). This connection can be implemented via a privately owned line between the two entities or in specific cases via publically available routes including the internet; however in this case the information needs to be encrypted by 106 and decrypted by 105 using a pre-agreed acceptable encryption protocol such as AES.

The meta hedge provider (103) actively contributes two way quotes on a price discovery platform (101) for the derivative linked to the value of the investment portfolio of the core entity. In one exemplary use, the derivative is a single stock future and the price discovery platform is the exchange OneChicago.

The market participant (100) may at any point decide to lift an offer or hit a bid contributed by the meta hedge provider. This action would trigger an internal process in the meta hedge provider by which the position entered into in the derivative would immediately be hedged by the said meta hedge provider using a portfolio replicating the exposure of the core entity at that point in time. The meta hedge provider (103) would subsequently leverage updates in portfolio composition received with its computer system (105) from the core investment vehicle system (106) in order to continuously adjust its hedge portfolio in line with the core entity's portfolio.

FIG. 2 details the specific in-kind creation and redemption process in the presence of a meta hedge provider (202).

At the end of the trading day, or at any other opportune time as determined by the market participant, the said market participant (205) can approach the Authorized participant (203) to exchange its position in the derivative linked to the value of the investment portfolio of the said core entity (206) against units of the said core entity.

In one embodiment at least, when the in-kind creation or redemption occurs, the meta hedge provider (202) enters into an exchange for swap with the market participant (205) essentially cancelling the derivative position for both entities, and simultaneously contributes the corresponding hedge portfolio for the in-kind creation/redemption process.

In one exemplary use, the market participant (205) is a market maker.

FIG. 3 summarizes the exposure of the core entity (301).

The exposure is the aggregate of the investment into the primary strategy (303) and the meta hedge provider (302). The core investment vehicle is the entity listed on the appropriate exchange. End investors (304) typically purchase and sell shares of the Core entity (301).

1. A computer-based method to enable end investors to allocate capital in and out of a primary active investment strategy; the method involving an investment vehicle consisting of a core entity listed on an exchange and a separate entity, the meta hedge provider, such that a private, reliable and confidential communication channel linking the network cards of the dedicated computer systems of the said core entity and the said meta hedge provider is available at all time; and the said core entity is invested in the said primary strategy as well as in the said meta hedge provider; and where at any point within at least a part of the regular market hours of the exchange on which the said core entity is listed, the said meta hedge provider commits to a purchase and a sale price for a set number of units of the said core entity; and where at any point the processor of a dedicated computer system within the said core entity calculates the composition of the said core entity investment portfolio based on information contained in the storage of the said core entity computer system, and will send composition updates via the said communication channel to the said meta hedge provider computer system; and when units of the said core entity are purchased or sold by the meta hedge provider, the said meta hedge provider will hedge the resulting exposure by executing a hedge portfolio mirroring the composition of the investment portfolio of the said core entity; and subsequently the said meta hedge provider will adjust the composition of its hedge portfolio in accordance to the updates it receives from the said core entity via the said communication channel.

2. A method as in claim 1, wherein the said meta hedge provider commits to purchase and sale prices of the said core entity by contributing bids and asks quotes on a standardized contract linked to the value of the said core entity and listed on an exchange; the said exchange not being required to be the same as the one on which the core entity is listed.

3. A method as in claim 2, wherein the said standardized contract is a single-stock future contract linked to the value of the said core entity.

4. A method as in claim 1, 2 or 3, wherein the said meta hedge provider is required to use separate and independent clearing firms and custodians from the said core entity.

5. A method as in claim 4, wherein the said core entity reports at a pre-determined frequency the amount of capital that it has invested in the said meta hedge provider.

6. A method as in claim 5, wherein the said core entity is the sole investor in the said meta hedge provider.

7. A method as in claim 5 or 6, wherein the said exchange-traded vehicle commits to systematically provide the break down in profitability between the core entity and the meta hedge provider when reporting financial performance.

8. A method as in claim 7, wherein specific minimum requirements are set and publicly disclosed by the said meta hedge provider with regards to the level of liquidity it provides at any point. Exemplary liquidity requirements include maximum acceptable quoted bid/offer spread and minimum quoting size.

9. A method as in claim 8, wherein a failure by the said meta hedge provider to meet the minimum liquidity requirements triggers a predetermined contingency operating mode.

10. A method as in claim 9, wherein the specific contingency operating mode consists of disclosing temporarily and publicly the dynamic composition of the said core entity investment portfolio; the said meta hedge provider commits during this contingency operating mode to maintain an electronic document publicly accessible over the internet; the said electronic document reporting the valuation and composition of the said core entity portfolio at all appropriate times. Instructions for accessing the document are disclosed at inception of the investment vehicle, and market participants are in a position to establish a connection from their computer systems to the computer system on which the said electronic document resides for testing purposes prior to a contingency operating mode event. Active market-makers will, when the said contingency operating mode is in effect, quote and hedge the said core entity using the information provided by the electronic document, until such time that the meta hedge provider regains its ability to meet the said minimum liquidity requirements.
